(19) United States
(12) Patent Application Publication
(10) Pub. No.: US 2025/0122450 A1
(43) Pub. Date: Apr. 17, 2025

(54) DISTILLERS MEAL WITH REDUCED MYCOTOXIN LEVELS AND METHODS OF REDUCING MYCOTOXIN CONTAMINATION

(71) Applicant: Novita Nutrition, LLC, Brookings, SD (US)

(72) Inventors: Donald L. Endres, Brookings, SD (US); Steven J. Furcich, Monticello, IL (US)

(21) Appl. No.: 18/729,852

(22) PCT Filed: Jan. 18, 2023
(86) PCT No.: PCT/US2023/011048

§ 371 Date: Jul. 17, 2024

Related U.S. Application Data
(60) Provisional application No. 63/300,537, filed on Jan. 18, 2022.
(60) Provisional application No. 63/267,346, filed on Jan. 31, 2022.

(51) Int. Cl. C12F 3/10; A23K 10/38; A23K 20/163

(52) U.S. Cl. CPC C12F 3/10; A23K 10/38; A23K 20/163

(57) ABSTRACT

A process for the reduction of the level of one or more mycotoxins from a co-product of bio-fuel production from fermentation of one or more grains or other biomass having fermentable sugars or starches. The one or more mycotoxins reduced from the co-product by a solvent extraction process to form distillers meal. The co-product can be distillers dried grains with solubles and/or distillers dried grains, such that the solvent extraction of the one or more mycotoxins provides distillers meal having a reduced level of the one or more mycotoxins compared to the co-product prior to the solvent extraction process. An optional washing process can also be used prior to or after the solvent extraction process to reduce mycotoxin levels. The resultant distillers meal having a reduced level of one or more mycotoxins deemed fit as an animal feed or animal feed supplement for one or more animals.

### FIELD OF THE INVENTION

The present invention relates generally to distillers meal having a reduced level of mycotoxins and methods of removing mycotoxins from a co-product of a fermentation process, such as an alcohol refining process. More particularly, described herein are methods for solvent extraction of mycotoxins from distillers dried grains with solubles and/or distillers dried grains to provide distillers meal having a reduced level of one or more mycotoxins, and animal feed supplements having the distillers meal with the reduced mycotoxin levels.

### BACKGROUND OF THE INVENTION

Ethanol can be produced using grains, such as corn, or other biomass containing fermentable sugars, which are renewable resources. Presently, the majority of ethanol-producing biorefineries in the United States are dry-grind corn biorefineries, and it is estimated that the present ethanol production capacity of such biorefineries runs into the billions of gallons each year. Other alcohols, such as C3-C6 alcohols, can also be produced by the fermentation process of fermentable sugars from grains and other biomass. By-products or co-products of the fermentation process using corn as the feedstock in a corn ethanol biorefining process are distillers corn oil (DCU), distillers dried grains (DDG) and distillers dried grains with solubles (DDGS). Based on recent production rates of ethanol from dry-grind ethanol plants, approximately 44 million metric tons of DDGS are produced in the United States annually. The fermentation process to produce other C3-C6 alcohols from fermentable sugars from biomass also produces similar distillers oil, distillers dried grains and distillers dried grains with solubles co-products.

Over the past few decades, achieving an ethanol product from grain-based biorefineries that is both commercial viable and truly renewable has proven challenging. Two of the more significant hurdles are: 1) the cost of grain-based ethanol production; and 2) the energy input to output ratio of grain-based ethanol production processes. As is easily appreciated, these two problems are intertwined. Grain-based ethanol production has historically required significant and costly input of fossil fuels (e.g., natural gas) to drive the biorefining process. Moreover, the amount of fossil fuel that has been historically required to drive grain-based ethanol production is costly, particularly so as the cost of natural gas and other fossil fuels increases. One of the ways by which the effective cost of grain-based ethanol production can be reduced is the sale of commercially valuable co-products of the biorefining process.

DDGS and DDG are co-products of grain-based ethanol production processes that have recognized commercial value. In particular, these co-products are sold as an animal feed, particularly a livestock feed supplement. Because it is primarily the starch of the grain that is consumed in the production of ethanol, the co-products remaining after fermentation and distillation contain nutritionally valuable fiber, protein and fat. Relative to raw grain, DDGS may even be considered a superior feed, as they contain concentrated amounts of fiber, protein and fat, together with a significantly reduced amount of starch. In addition, DDGS are considerably less expensive than some feeds of comparable nutritional value.

Several known fungal plant pathogens can produce mycotoxins that may contaminate feedstocks, such as corn or other grains, destined for fuel alcohol, such as ethanol or isobutanol, production and the resulting DDGS and/or DDG. Mycotoxins are defined as molecules of low molecular weight produced by fungi that elicit a toxic response through a natural route of exposure both in humans and other vertebrate animals. The Food and Agriculture Organization estimates that over one quarter of the world's crops are affected by mycotoxins every year, with annual losses of around 1 billion metric tons of food. These losses are felt by crop producers, animal producers, grain handlers, processors, food manufacturers, and consumers across the farm-food-fork continuum.

A variety of fungal species mostly from the genera Aspergillus, Penicillium, Fusarium, Alternaria, or Claviceps are known to produce mycotoxins. These toxins have a considerable pharmacological effect, even at very low concentrations (parts per billion), while toxicity may be further enhanced by metabolism in vivo. Most important in terms of toxicity and occurrence are aflatoxins B₁, B₂, G₁, and G₂ (AFB₁, AFB₂, AFG₁, AFG₂) produced typically by Aspergillus parasiticus, Aspergillus flavus, Aspergillus nomius, Aspergillus pseudotamarri; ochratoxin A (OTA) produced typically by Aspergillus alutaceus, Aspergillus carbonarius, Penicillium verrucosum; fumonisins B₁, B₂, and B₃ (FB₁, FB₂, FB₃) produced typically by Fusarium verticillioides, Fusarium proliferatum, Aspergillus niger; deoxynivalenol (DON) produced typically by Fusarium graminearum, Fusarium culmorum and other trichothecenes (T-2 toxin, HT-2 toxin and nivalenol (NIV)) typically produced by Fusarium sporotrichioides, Fusarium langsethiae, Fusarium poae, Fusarium cerealis, Fusarium culmorum and Fusarium graminearum; zearalenone (ZEN) produced by Fusarium species; patulin (PAT) produced by Byssochlamys, Penicillium and Aspergillus species; and ergot alkaloids (EAs) produced by Claviceps species.

Aflatoxins can cause growth reduction, suppressed immunity, reduced feed efficiency and increased mortality in cattle, among other symptoms. In pigs, reduced feed efficiency, increased mortality, and lower growth rates can be observed. In poultry, there are similar symptoms and a decreased ability to metabolize fat, protein and starch. The FDA has established action levels of 20 ppb for grain and feed products, and 0.5 ppb for milk.

Zearalenone in cattle and pigs mimics oestrogen and produces a considerable reduction in reproductive performance, reduced growth, reduced milk production and reduced feed efficiency. In poultry, increased mortality is observed. Recommended maximum concentrations of zearaleonone for cattle is around 25 ppm.

DON causes severe symptoms in cattle, pigs and poultry, including gastric effects such as vomiting, reduced growth rates, reduced egg production, scours and reduced feed efficiency. Recommended maximum concentrations of DON are 5 ppm in total ration and 10 ppm in grain for ruminating beef.

Fumonisin produces negative effects via a reduction in blood circulation and cardiac output, at least in part by agonising sphingosine receptors. In this way they reduce growth and cause pulmonary oedema in swine and poultry. This reduction of circulation affects all major organs including the liver and can exacerbate and enhance the effects of other toxins that may also be present. The toxin causes liver damage and decreased milk production in dairy cattle at levels greater than 100 ppm. Usually levels in feeds exist at the 1-10 ppm range.

Ochratoxin can be carcinogenic in man and produces immuno-suppression in farm animals.

The FDA also requires feed products for domestic animals for companionship (e.g., dogs, cats, rabbits and other animals normally kept inside a dwelling) to contain no more than 20 ppb of aflatoxin, 5 ppm DON and 10 ppm fumonisins.

DDGS and/or DDG may be contaminated with many of the foregoing mycotoxins, the most common mycotoxins for corn DDGS and/or DDG including: AFB₁, AFB₂, AFG₁, AFG₂, OTA, FB₁, FB₂, FB₃, DON, T-2 toxin, HT-2 toxin and ZEN. An unintended consequence of feeding livestock DDGS and/or DDG is that animals are likely to be fed higher levels of mycotoxins, which are concentrated up to three times in DDGS compared to grain. When domestic animals including livestock ingest one or more mycotoxins, the effect on health could be acute, meaning evident signs of disease are present or even causing death. However, acute manifestation of mycotoxicosis is rare under farm conditions. The effects of mycotoxin ingestion are mainly chronic, implying hidden disorders with reduced ingestion, productivity and fertility. Such effects cause severe economic losses through clinically ambiguous changes in animal growth, feed intake reduction or feed refusal, alteration in nutrient absorption and metabolism, effects on the endocrine system as well as suppression of the immune system. While ruminants are considered to be less susceptible to negative effects of mycotoxins than monogastrics due in part to rumen microflora and feed particles contained in rumen being effective in the degradation, deactivation or binding of these toxic molecules and rumen microorganisms being able to reduce development of pathogens, the negative effects of mycotoxin ingestion on the health status and performance of cattle and the evaluation of the real economic impact of mycotoxins on ruminant livestock production system are starting to be better understood. It is believed that mycotoxins may have a direct effect on rumen microbiota, which affects the kinetics of gas production.

DDGS contaminated with a single mycotoxin may contribute to significant losses over $100 million annually, with total losses likely to be significantly more when accounting for multiple mycotoxins affecting more than one animal, crop, or commodity. With the increase of global demand for maize, wheat, soybeans, and their products due to the steady growth and strengthening of the livestock industry, animal feed safety has gradually become more important, with mycotoxins representing one of the most significant hazards. In an attempt to avoid the adverse effects and implications discussed above, several worldwide institutions and organizations have restricted the accepted levels of certain mycotoxins in animal feeds, since truly mycotoxin-free feedstuffs are impossible to guarantee.

Pet food industry stakeholders have also recently become more aware of the risks that mycotoxins pose and have begun taking steps to balance the benefits against financial and reputation costs associated with recalled feed products. In response to these risk factors, many companies not only test ingredients for a full range of mycotoxins but also maintain tighter restrictions of their levels than those proposed by current regulatory guidelines

Various practices and processes have been implemented to reduce mycotoxin levels in food commodities, including physical removal by manual sorting of the crop product, processing measures (dehulling, steeping, milling, heat treatment and irradiation), chemical detoxification (chemical transformations which reduce the toxicity), enzymatic detoxification (enzymatic transformation which reduce the toxicity) and inactivation mycotoxins with a sequestering agent.

For example, U.S. Pat. No. 5,165,946 is directed at inactivating mycotoxins by adding a phyllosilicate/sequesterant formulation to animal feed as a mycotoxin inactivating agent; U.S. Pat. No. 6,045,834 is directed at a modified yeast cell wall extract and mineral clay fed to animals to inactivate mycotoxins; U.S. Pat. No. 9,901,108 is directed to a mycotoxin-reducing composition comprising an enzyme, mycotoxin-binding agent and a specific yeast; U.S. Pat. No. 10,721,950 is directed at removal of mycotoxins from insoluble protein products using a mycotoxin sequestering agent and density-based particle separators; U.S. Pat. No. 8,119,172 is directed to microorganisms for the biological inactivation or detoxification of mycotoxins; U.S. Pat. No. 8,426,541 is directed to molecularly imprinted polymers for mycotoxin sequestration; and U.S. Patent Publication No. 2004/0185148 is directed to a method of producing an animal feed from co-products of dry corn milling by mixing with an additive that improves the amino acid profile and extruding at high temperatures.

However, current techniques using mycotoxin-binding agent and removal of mycotoxins are only partly successful. Some mycotoxins remain toxic even when attached to a binding agent, while some toxins do not bind efficiently at normal in vivo concentrations. Higher contamination levels are also an issue as the current recommended levels of binders may not be sufficient to remove all toxins present. Alternative techniques that use enzymes or microorganisms to break down mycotoxins, to reduce toxicity, often are not effective at reducing mycotoxin content sufficiently, which may be due to a dynamic equilibrium in the gastro-intestinal tract, which prevents excretion of the toxins.

In the interests of the health of both humans and animals, there is a need for mycotoxins to be reduced, or preferably removed altogether, from the food chain. Therefore, there exists a need in the industry to deal with mycotoxin-contaminated feeds and feed supplements in an efficient and cost-effective manner. There also exists a need in the industry for an efficient and cost-effective process for the removal or reduction of mycotoxins from co-products of dry grind alcohol processing, such that the co-products can be safely fed to livestock as an animal feed or animal feed supplement.

### BRIEF DESCRIPTION OF THE DRAWINGS

FIG. 1 provides a flow-chart schematic of the process by which mycotoxin levels are reduced by a solvent extraction of DDGS, DDG or a combination thereof.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### SUMMARY

The present disclosure is directed to a process for the reduction of the level of one or more mycotoxins from a co-product of a fermentation process of fermentable sugars from grains and/or other biomass to produce alcohols, such as C2-C6 alcohols. The reduction of the one or more mycotoxins from the co-product by a solvent extraction process forms distillers meal, wherein the distillers meal having a reduced level of the one or more mycotoxins compared to the co-product prior to the solvent extraction process. The resultant distillers meal having a reduced level of one or more mycotoxins deemed fit as an animal feed or animal feed supplement for one or more animals.

In some aspects, the present invention is directed at a method of producing a distillers meal having a reduced level of one or mycotoxins, the method including comprising providing a co-product resulting from a fermentation process of a dry-grind biofuel production facility, wherein the dry-grind biofuel production facility uses a bio-based feedstock to produce a biofuel and the co-product, the co-product comprising distillers dried grains with solubles, distiller's dried grains, or a combination thereof, and wherein one or more mycotoxins are present in the co-product; and conducting solvent extraction of the co-product in the presence of one or more solvents to extract an amount of one or more mycotoxins from the co-product and provide a distillers meal; wherein the distillers meal has a level of the one or more mycotoxins that is reduced compared to the co-product prior to the solvent extraction process.

In some aspects, the present invention is directed at a biorefinery at a single facility configured to produce a distillers meal having a reduced level of one or more mycotoxins, the facility comprising a dry-grind biofuel production facility configured to process a bio-based feedstock to produce a biofuel and a co-product, the co-product comprising distillers dried grains with solubles, distiller's dried grains, or a combination thereof, and wherein one or more mycotoxins are present in the co-product; and a solvent extraction facility configured to extract one or more mycotoxins from the co-product and provide a distillers meal; wherein the distillers meal has a level of the one or more mycotoxins that is reduced compared to the co-product prior to the solvent extraction process.

In some aspects, the present invention is directed at distillers meal produced from a dry-grind biofuel production facility configured to process a bio-based feedstock to produce a biofuel and a co-product, wherein the co-product is subjected to a solvent extraction process providing the distillers meal, the distillers meal comprising a crude protein content ranging from about 28% to about 35% by weight on a dry matter basis, a crude fat content ranging from about 0.25% to about 6% by weight on a dry matter basis; wherein the distillers meal has a level of the one or more mycotoxins that has been reduced by solvent extraction compared to the co-product.

In some aspects, the present invention is directed at an animal feed ingredient comprising distillers meal produced from a dry-grind biofuel production facility configured to process a bio-based feedstock to produce a biofuel and a co-product, the co-product comprising distillers dried grains with solubles, distiller's dried grains, or a combination thereof, wherein the co-product is subjected to a solvent extraction process providing the distillers meal, wherein the distillers meal having a crude protein content ranging from about 28% to about 35% by weight on a dry matter basis, a crude fat content ranging from about 0.25% to about 6% by weight on a dry matter basis, wherein the distillers meal has a level of the one or more mycotoxins that has been reduced by solvent extraction compared to the co-product.

In some aspects, the bio-based feedstock comprises one or more fermentable sugars or starches, preferably one or more grains or biomass, more preferably corn, barley, rye, sorghum, or soybean.

In some aspects, the one or more mycotoxins is chosen from aflatoxin B₁ (AFB₁), aflatoxin B₂ (AFB₂), aflatoxin G₁ (AFG₁), aflatoxin G₂ (AFG₂), ochratoxin A (OTA), fumonisin B₁ (FB₁), fumonisin B₂ (FB₂), fumonisin B₃ (FB₃), deoxynivalenol (DON) trichothecene T-2 toxin (T-2) trichthecene HT-2 toxin (HT-2), nivalenol (NIV), zearalenone (ZEN), patulin (PAT), one or more ergot alkaloids (EAs), and combinations thereof.

In some aspects, the distillers meal comprises a residual level of the non-polar solvent in an amount of about 10 ppm to about 1000 ppm, more preferably between about 10 ppm and about 500 ppm.

In some aspects, distillers meal is corn distillers meal produced by solvent extraction of corn distillers dried grains with solubles, corn distiller's dried grains, or a combination thereof.

In some aspects, the distillers meal is produced by solvent extraction of corn distillers dried grains with soluble, corn distiller's dried grains, or a combination thereof, the solvent comprising one or more alkanes C₅-C₇-alkanes chosen from n-pentane, n-hexane, n-heptane, isopentane, neopentane, isohexane, 2-methylepentane, 2,3-dimethylbutane, neohexane, isoheptane, 2-methylhexane, 2,2-dimethylpentane, 2,3-dimethylpentane, 2,4-dimethyl pentane, 3-ethylpentane, and 2,2,3-trimethylbutane, petroleum ether, or mixtures thereof. In some aspects, the distillers meal is produced by solvent extraction of the co-product with at least one renewable solvent, preferably the at least one renewable solvent comprising 2-methyloxolane.

In some aspects, the distillers meal is produced by solvent extraction of the co-product with at least one polar solvent, preferably the at least one polar solvent comprising ethanol, isopropanol, or a combination thereof.

In some aspects, the distillers meal is produced by solvent extraction of the co-product with at least one non-polar solvent having a boiling point in the range of about 36° C. to about 99° C.

In some aspects, the distillers meal is produced by solvent extraction of the co-product with a solvent blend comprising at least one non-polar solvent and at least one polar solvent, preferably wherein the solvent blend forms an azeotrope.

In some aspects, the distillers meal is produced by solvent extraction of the co-product with a solvent blend, the solvent blend comprising at least one renewable solvent and at least one non-polar solvent, wherein the solvent blend optionally further comprises at least one polar solvent.

In some aspects, the solvent extraction process removes about 20% or more, about 25% or more, about 30% or more, about 35% or more, about 40% or more, about 45% or more, about 50% or more, about 55% or more, about 60% or more, about 65% or more, about 70% or more, about 75% or more, and in some aspects about 80% or more, of one or more mycotoxins present in the co-product prior to solvent extraction to provide the distillers meal.

In some aspects, the solvent extraction process removes between about 20% and about 80%, in some aspects between about 25% and about 80%, in some aspects between about 30% and about 80%, in some aspects between about 35% and about 80%, in some aspects between about 45% and about 80%, in some aspects between about 50% and about 80%, in some aspects between about 55% and about 80%, and in some other aspects between about 60% and about 80° %, of one or more mycotoxins present in the co-product prior to solvent extraction to provide the distillers meal.

In some aspects, the solvent extraction process removes between about 20% and about 50%, in some aspects between about 20% and about 45%, in some aspects between about 20% and about 40%, of one or more mycotoxins present in the co-product prior to solvent extraction to provide the distillers meal.

In some aspects, the co-product comprises one or more aflatoxins chosen from AFB₁, AFB₂, AFG₁, AFG₂, and combinations therefore, at an action level prior to the solvent extraction process and at an acceptable level after the solvent extraction level, wherein the action level is greater than 300 ppb and the acceptable level less than 300 ppb, in some aspects the action level greater than 200 ppb and the acceptable level less than 200 ppb, in some aspects the action level greater than 100 ppb and the acceptable level less than 100 ppb, in some aspects the action level greater than 20 ppb and the acceptable level less than 20 ppb, and in some preferred aspects the action level greater than 20 ppb and the acceptable level at a non-detectable level of less than 1.00 ppb.

In some aspects, the co-product comprises zearalenone at an action level prior to the solvent extraction process and at an acceptable level after the solvent extraction level, wherein the action level is greater than 25 ppm and the acceptable level less than 25 ppm, in some aspects the action level greater than 10 ppm and the acceptable level less than 10 ppm, in some aspects the action level greater than 5 ppm and the acceptable level less than 5 ppm, in some aspects the action level greater than 2 ppm and the acceptable level less than 2 ppm, in some aspects the action level greater than 500 ppb and the acceptable level less than 500 ppb, in some aspects the action level greater than 300 ppb and the acceptable level less than 300 ppb, and in some preferred aspects the action level greater than 300 ppb and the acceptable level at a non-detectable level of less than 12.50 ppb.

In some aspects, the co-product comprises one or more fumonisins including FB₁, FB₂, FB₃, and combinations thereof, at an action level prior to the solvent extraction process and at an acceptable level after the solvent extraction level, wherein the action level is greater than 100 ppm and the acceptable level less than 100 ppm, in some aspects the action level greater than 60 ppm and the acceptable level less than 60 ppm, in some aspects the action level greater than 50 ppm and the acceptable level less than 50 ppm, in some aspects the action level greater than 10 ppm and the acceptable level less than 10 ppm, in some aspects the action level greater than 5 ppm and the acceptable level less than 5 ppm, in some preferred aspects the action level greater than 5 ppm and the acceptable level at a non-detectable level less than 0.10 ppm.

In some aspects, the co-product comprises DON at an action level prior to the solvent extraction process and at an acceptable level after the solvent extraction level, wherein the action level is greater than 5 ppm and the acceptable level less than 5 ppm, in some aspects the action level greater than 2 ppm and the acceptable level less than 2 ppm, in some aspects the action level greater than 1 ppm and the acceptable level less than 1 ppm, in some aspects the action level greater than 0.5 ppm and the acceptable level less than 0.5 ppm.

In some aspects, the co-product comprises T-2 at an action level prior to the solvent extraction process and at an acceptable level after the solvent extraction level, wherein the action level is greater than 750 ppb and the acceptable level less than 750 ppb, in some aspects the action level greater than 500 ppb and the acceptable level less than 500 ppb, in some aspects the action level greater than 300 ppb and the acceptable level less than 300 ppb, in some aspects the action level greater than 100 ppb and the acceptable level less than 100 ppb.

In some aspects, the distillers meal is provided in an animal feed or an animal feed supplement for an animal chosen from beef cattle, dairy cattle, equine, sheep, swine, fish, chickens, geese, turkey, rabbits, goats, cats and dogs.

In some aspects, the distillers meal is substantially free of a non-native emulsifier or a non-native flocculent.

In some aspects, the distillers meal has at least a 50% reduced level of an emulsifier or a flocculent than distillers dried grain solubles that has been subjected to a corn stillage oil recovery process.

In some aspects, at least 95% of the distillers meal has a particle size less than about 1 millimeter.

In some aspects, the distillers meal is provided in the form of a pellet.

In some aspects, the distillers meal is essentially free of one or more mycotoxins that was present in the co-product prior to the solvent extraction process.

In some aspects, the solvent extraction process of the co-product provides a feedstock that can be used in further processing to make a protein enriched or purified/isolated protein product, preferably a purified/isolated corn protein product, wherein the purified/isolated protein product can be used as a feed supplement, feed formula or feed product for one or more of the foregoing disclosed animals.

In some aspects, a washing process for reducing a level of one or more mycotoxins is employed, wherein the washing process is employed prior to the solvent extraction process or after the solvent extraction process.

In some aspects, the resultant distillers meal from the solvent extraction process of the co-product and an optional water washing process provides a distillers meal having a higher protein content than the original DDGS. DDG or combination thereof.

In some aspects, the distillers meal blended with one or more mycotoxin binders, wherein the one or more mycotoxin binders comprising an acid activated clay, a non-acid activated clay, bentonite clay, zeolite clay, diatomaceous earth, kaolin, a silica based product, aluminosilicates, sodium calcium aluminosilicates, activated charcoal, glucomannan, chlorella, humic acid, calcium carbonate, and combinations thereof.

In some aspects, the distillers meal blended with one or more mycotoxin binders, wherein the one or more mycotoxin binders comprising the resultant bleaching components from a bleaching treatment of a bio-oil derived from the DDGS, DDG and a combination thereof.

In some aspects, the distillers meal blended with one or more mycotoxin binders, wherein a bioavailable amount of mycotoxins is reduced in comparison to the distillers meal prior to being blended with the one or more mycotoxin binders.

In some aspects, the distillers meal is substantially devoid of any mycotoxin binder.

### DETAILED DESCRIPTION OF THE DRAWINGS

The terms “distillers oil” or “DO” referred to herein shall mean a co-product of a bio-fermentation process using biomass for fermentation that is extracted from the thin stillage.

The terms “distillers corn oil” or “DCO” referred to herein shall mean a coproduct of dry-milled corn alcohol production that is extracted from the thin stillage, including corn ethanol production, corn isobutanol production, and other C2-C6 alcohol production.

The terms “distiller's dried grains with solubles” or “DDGS” referred to herein shall mean a co-product of dry-milled alcohol production having the AAFCO definition, which is the product obtained after the removal of ethyl alcohol by distillation from the yeast fermentation of corn, grain or a grain mixture by condensing and drying at least three-quarters of the solids of the resultant whole stillage by methods employed in the grain distilling industry, wherein the predominating grain can precede the terms (e.g., corn DDGS, barley DDGS, wheat DDGS, etc.).

The terms “dried distiller's grains” or “distiller's dried grains” or “DDG” referred to herein shall mean a co-product of dry-milled ethanol production having the AAFCO definition, which is the product obtained after the removal of ethyl alcohol by distillation from the yeast fermentation of corn, grain or a grain mixture by separating the resulting coarse grain fraction of the whole stillage and drying it by methods employed in the grain distilling industry, wherein the predominating grain can precede the terms (e.g., corn DDG, barley DDG, wheat DDG, etc.).

The term “distillers meal” referred to herein shall mean the product or co-product resulting from solvent extraction of DDGS, DDG or a combination thereof that has been dried of excess water, including the instance of the resultant product or co-product retaining substantially all the crude protein and fiber content of the respective DDGS, DDG or a combination thereof prior to solvent extraction, and also including the instance of the resultant product or co-product having a portion of the fiber and/or soluble fractions reduced by any further processes such that the resultant product or co-product has a higher protein content than the DDGS, DDG or a combination thereof prior to solvent extraction.

It will be readily understood that the methods and materials as they are generally described and illustrated in the FIGURES herein could be arranged and designed in a wide variety of different configurations. Thus, the following more detailed description of various embodiments of the methods and materials provided herein is not intended to limit the scope of the claims, but merely provides representative examples of various embodiments of the subject matter recited in the appended claims.

For example, though DDGS are referenced herein with respect to the methods and materials described, it is to be understood that DDG could also be utilized instead of or in addition to the DDGS. In particular, DDG retain significant oil content, and in embodiments of the processes and methods described herein DDG may be used in place of DDGS or in combination with DDGS. Also, while every ethanol plant is configured differently, each ethanol plants handles recycle streams differently, including recycling different process streams of solubles to the distilled dried grains. Additionally, ethanol plants may also contain a commercial production of other biobased alcohols, such as isobutanol, alongside ethanol. Still further, biobased alcohol production can relate any of the C2-C6 alcohol productions. Thus, the following description specific to DDGS should also be understood to be applicable to DDG or a combination of DDGS and DDG as it relates to the various grain and/or biomass feedstocks.

As is described herein, the commercial value of DDG and DDGS from grain-based alcohol production processes can be further enhanced, including ethanol production processes, isobutanol production processes, and the like. In particular, commercially valuable amounts of distillers meal with mycotoxin levels reduced can be provided using a solvent extraction process.

The distillers meal resulting from solvent extraction as described herein is suitable for use as an animal feed ingredient, such as, for example, a feed supplement or constituent for domestic pets (such as dogs, cats, rabbits and other animals normally kept inside a dwelling), livestock (such as beef cattle, dairy cattle, equine, sheep and/or swine), aquaculture or poultry, including chickens, geese and/or turkey. Therefore, solvent extraction of DDG and/or DDGS according to the methods described herein may facilitate a reduction in the effective costs of producing bio-based fuels from a grain-based and/or biomass biorefinery, as it allows for production of multiple, commercially-valuable products from DDG and DDGS. In some preferred aspects, the bio-based fuels comprising C2-C6 alcohols, such as ethanol and/or isobutanol, produced from the starch or sugars of plants, including grains and biomass, such as corn.

In one embodiment, alcohol production, solvent extraction of DDGS, and any distillers meal refining into an animal feed and/or animal feed ingredient can occur in a single facility. For example, in such an embodiment, a grain-based ethanol biorefinery may further include facilities for solvent extraction of the DDGS produced at the biorefinery. In another such embodiment, a grain-based ethanol biorefinery may further include facilities for solvent extraction of the DDGS produced at the biorefinery and facilities for processing the resultant distillers meal to provide an animal feed and/or animal feed ingredient. By integrating these operations within a single facility, process efficiencies may be gained and costs of solvent extracting the DDGS and processing or refining the resultant distillers grain may be reduced.

In some aspects, the DDGS. DDG or a combination thereof may be deemed unfit for use as an animal feed and/or animal feed ingredient due to the one or more mycotoxins exceeding a maximum limit prior to a solvent extraction process, whereby the distillers meal after the solvent extraction process has reduced the levels of one or more mycotoxins such that the distillers meal is rendered fit for use as an animal feed and/or animal feed ingredient.

Solvent Extraction of Mycotoxins from DDGS and/or DDG

Using solvent extraction processes, significant amounts of one or more mycotoxins can be removed from DDGS, DDG or a combination thereof, while maintaining the value of the DDGS. DDG or a combination thereof, as a feed supplement. In some aspects, significant amounts of one or more mycotoxins can be removed from DDGS, DDG or a combination thereof, using solvent extraction processes, which renders a previously deemed unfit co-product that is now rendered fit for use as an animal feed and/or animal feed ingredient.

In one embodiment, the co-product used in a solvent extraction process as described herein are selected from DDGS, DDG or a combination thereof, generated in bio-based fuel production, including processes that comprise the fermentation of sugars or starches, such as dry-mill ethanol production processes, that utilize grains, such as corn, barley, rye, sorghum, or soybean grain or other biomass having fermentable sugars or starches. In another embodiment, the DDGS. DDG or a combination thereof, used in a solvent extraction process are corn DDGS, corn DDG or a combination thereof generated from a dry-grind corn ethanol biorefinery. In yet another embodiment, the DDGS, DDG or a combination thereof, used in a solvent extraction process are corn DDGS, corn DDG or a combination thereof, generated from a dry-grind corn isobutanol process.

In some preferred aspects, the feedstock for bio-based fuel production comprises corn. In some more preferred aspects, the feedstock comprises #2 yellow dent corn, which represents about 99% of corn grown in the U.S. and currently used for animal feed and industrial uses. In some aspects, corn comprises at least 50%, in some aspects at least 55%, in some aspects at least 60%, in some aspects at least 65%, in some aspects at least 70%, in some aspects at least 75%, in some aspects at least 80%, in some aspects at least 85%, in some aspects at least 90%, in some aspects at least 95%, in some aspects at least 99%, and in some aspects 100%, of the feedstock for the bio-based fuel production that results in the coproduct production of DDGS, DDG or a combination thereof.

Solvent extraction processes suitable for extraction of one or more mycotoxins from DDGS, DDG or combinations thereof include processes that utilize one or more solvents. In some aspects, the one or more solvents include ethanol, hexane, iso-hexane, 2-methyloxolane, petroleum distillate, mixtures thereof, or one or more other suitable solvents. In one preferred aspect, solvent extraction processes suitable for extracting one or more mycotoxins from DDGS, DDG or combinations thereof include processes that utilize one or more renewable solvents, such as 2-methyloxolane. In some aspects, solvent extraction processes suitable for extraction of one or more mycotoxins from DDGS, DDG or combinations thereof include processes that utilize suitable non-polar solvents. In some aspects, solvent extraction processes suitable for extraction of one or more mycotoxins from DDGS, DDG or combinations thereof include processes that utilize suitable polar solvents. In some aspects, solvent extraction processes suitable for extraction of one or more mycotoxins from DDGS, DDG or combinations thereof include processes that utilize commercially available solvents that are acceptable regulatory-recognized solvents and/or can be readily removed from the resulting product by commonly accepted methods such as distillation, washing and/or evaporation. One of ordinary skill in the art will appreciate that such solvents may be commercial grade or reagent grade solvents.

In some aspects, suitable non-polar solvents comprise saturated hydrocarbons, such as one or more C5-C7-alkanes, particularly n-pentane, n-hexane and n-heptane, as well as the structural isomers thereof (i.e., isopentane, neopentane, isohexane, 2-methylepentane, 2,3-dimethylbutane, neohexane, isoheptane, 2-methylhexane, 2,2-dimethylpentane, 2,3-dimethylpentane, 2,4-dimethylpentane, 3-ethylpentane, and 2,2,3-trimethylbutane), petroleum ether, or mixtures thereof.

In some aspects, suitable solvents are renewable solvents, such as 2-methyloxolane alone or in combination with one or more suitable non-polar solvents.

In some aspects, suitable solvents or mixtures thereof have a boiling point in the range from about 36° C. to about 99° C. In some aspects, suitable non-polar solvents or mixtures thereof have a boiling point in the range from about 36° C. to about 99° C. In some aspects, the non-polar solvents may be purified or commercial grade. For example, in some aspects, a suitable non-polar solvent includes commercial grade hexane, which one of ordinary skill in the art will appreciate comprises a mixture of n-hexane, other isomers of hexane and small amounts of other miscellaneous hydrocarbons (i.e., acetone, methyl ethyl ketone, dichloromethane, and trichloroethylene, aromatics such as toluene and/or other types of petroleum hydrocarbons).

In some aspects, suitable solvents comprise mixtures of solvents containing alkanes or blends of non-polar and polar solvents that form azeotropes. For example, suitable blends of non-polar and polar solvents may include hexane:ethanol or hexane:isopropanol. Such solvents forming an azeotrope may also include ketones such as acetone. In some aspects, the azeotrope comprises a blend of polar and non-polar solvents, such that the blend is a positive azeotrope, which has a boiling point at a lower temperature than any other ratio of its constituents. In some other aspects, the azeotrope comprises a blend of a polar solvent and/or a non-polar solvent with one or more ketones, such as acetone.

In some other preferred aspects, suitable solvents comprise mixtures of solvents containing alkanes or blends of renewable solvents and non-polar solvents, polar solvents, or a mixture thereof. For example, suitable blends of renewable and non-polar solvents may include 2-methyloxolane:hexane, suitable blends of renewable and polar solvents may include 2-methyloxolane:ethanol or 2-methyloxolane:isopropanol, and suitable blends of renewable, non-polar and polar solvents may include 2-methyloxolane:hexane:ethanol or 2-methyloxolane:hexane:isopropanol. Such solvents may also include ketones such as acetone. In some aspects, the suitable blends forms an azeotrope, which comprises a blend of polar and non-polar solvents, such that the blend is a positive azeotrope, which has a boiling point at a lower temperature than any other ratio of its constituents.

In one embodiment, the solvent extraction process utilizes a solvent, such as, for example, hexane and/or 2-methyloxolane that serves to remove one or more mycotoxins from the co-product without substantially altering the protein or fiber content of the resultant distillers meal as compared to the starting co-product. The removal of one or more mycotoxins from the co-product by solvent extraction as described herein yields a distillers meal.

In some aspects, the solvent extraction removes one or more mycotoxins chosen from the group consisting of AFB₁, AFB₂, AFG₁, AFG₂, FB₁, FB₂, FB₃, DON, ochratoxin, T-2, HT-2, NIV, ZEN. PAT, and EAs. In some preferred aspects, the solvent extraction removes one or more mycotoxins chosen from the group consisting of AFB₁, AFB₂, AFG₁, and AFG₂. In some other preferred aspects, solvent extraction removes one or more mycotoxins chosen from the group consisting of AFB₁, AFB₂, AFG₁, and AFG₂, T-2, HT-2 and ZEN. In still other aspects, the solvent extraction removes one or more Type A trichothecene mycotoxins, such as neosolaniol, T-2 toxin, trichodermin, 4,15-diacetoxyscirpenol and harzianum A. In still other aspects, the solvent extraction removes one or more Type B trichothecene mycotoxins, such as NIV, DON and trichothecin. In still other aspects, the solvent extraction removes one or more Type C trichothecene mycotoxins, such as crotocin. In still other aspects, the solvent extraction removes one or more Type D trichothecene mycotoxins, such as roridin A, verrucarin A and satratoxin H.

In one embodiment, the solvent extraction process removes about 20% or more, about 25% or more, about 30% or more, about 35% or more, about 40% or more, about 45% or more, about 50% or more, about 55% or more, about 60% or more, about 65% or more, about 70% or more, about 75% or more, and in some aspects about 80% or more, of one or more mycotoxins present in the co-product prior to solvent extraction. In some aspects, the solvent extraction process removes between about 20% and about 80%, in some aspects between about 25% and about 80%, in some aspects between about 30% and about 80%, in some aspects between about 35% and about 80%, in some aspects between about 45% and about 80%, in some aspects between about 50% and about 80%, in some aspects between about 55% and about 80%, and in some other aspects between about 60% and about 80%, of one or more mycotoxins present in the co-product prior to solvent extraction. In some other aspects, the solvent extraction process removes between about 20% and about 50%, in some aspects between about 20% and about 45%, in some aspects between about 20% and about 40%, of one or more mycotoxins present in the co-product prior to solvent extraction.

In another embodiment, the solvent extraction process comprises at least one non-polar solvent that removes about 20% or more, about 25% or more, about 30% or more, about 35% or more, about 40% or more, about 45% or more, about 50% or more, about 55% or more, about 60% or mom, about 65% or more, about 70% or more, about 75% or more, and in some aspects about 80% or more, of one or more mycotoxins present in the co-product prior to solvent extraction. In some aspects, the solvent extraction process comprising at least one non-polar solvent removes between about 20% and about 80%, in some aspects between about 25% and about 80%, in some aspects between about 30% and about 80%, in some aspects between about 35% and about 80%, in some aspects between about 45% and about 80%, in some aspects between about 50% and about 80%, in some aspects between about 55% and about 80%, and in some other aspects between about 60% and about 80%, of one or more mycotoxins present in the co-product prior to solvent extraction. In some other aspects, the solvent extraction process comprising at least one non-polar solvent removes between about 20% and about 50%, in some aspects between about 20% and about 45%, in some aspects between about 20% and about 40%, of one or more mycotoxins present in the co-product prior to solvent extraction. In some aspects, the co-product is corn DDGS, corn DDG or a combination thereof. In some aspects, the at least one non-polar solvent comprises hexane.

In another embodiment, the solvent extraction process comprises at least one renewable solvent that removes about 20% or more, about 25% or more, about 30% or more, about 35% or more, about 40% or more, about 45% or more, about 50% or more, about 55% or more, about 60% or more, about 65% or more, about 70% or more, about 75% or more, and in some aspects about 80% or more, of one or more mycotoxins present in the co-product prior to solvent extraction. In some aspects, the solvent extraction process comprising at least one renewable solvent removes between about 20% and about 80%, in some aspects between about 25% and about 80%, in some aspects between about 30% and about 80%, in some aspects between about 35% and about 80%, in some aspects between about 45% and about 80%, in some aspects between about 50% and about 80%, in some aspects between about 55% and about 80%, and in some other aspects between about 60% and about 80%, of one or more mycotoxins present in the co-product prior to solvent extraction. In some other aspects, the solvent extraction process comprising at least one renewable solvent removes between about 20% and about 50%, in some aspects between about 20% and about 45%, in some aspects between about 20% and about 40%, of one or more mycotoxins present in the co-product prior to solvent extraction. In some aspects, the co-product is corn DDGS, corn DDG or a combination thereof. In some aspects, the at least one renewable solvent comprises 2-methyloxolane.

In another embodiment, the solvent extraction process comprises at least one polar solvent that removes about 20% or more, about 25% or more, about 30% or more, about 35% or more, about 40% or more, about 45% or more, about 50% or more, about 55% or more, about 60% or more, about 65% or more, about 70% or more, about 75% or more, and in some aspects about 80% or more, of one or more mycotoxins present in the co-product prior to solvent extraction. In some aspects, the solvent extraction process comprising at least one polar solvent removes between about 20% and about 80%, in some aspects between about 25% and about 80%, in some aspects between about 30% and about 80%, in some aspects between about 35% and about 80%, in some aspects between about 45% and about 80%, in some aspects between about 50% and about 80%, in some aspects between about 55% and about 80%, and in some other aspects between about 60% and about 80%, of one or more mycotoxins present in the co-product prior to solvent extraction. In some other aspects, the solvent extraction process comprising at least one polar solvent removes between about 20% and about 50%, in some aspects between about 20% and about 45%, in some aspects between about 20% and about 40%, of one or more mycotoxins present in the co-product prior to solvent extraction. In some aspects, the co-product is corn DDGS, corn DDG or a combination thereof. In some aspects, the at least one polar solvent comprises ethanol, isopropanol or a combination thereof.

In yet another embodiment, the solvent extraction process is an extraction process using a mixture of one or more solvents having a boiling point range between about 36° C. to about 99° C. In some aspects, the one or more solvents having a boiling point range between about 36° C. to about 99° C. comprises at least one non-polar solvent. In some other aspects, the one or more solvents having a boiling point range between about 36° C. to about 99° C. comprises at least one non-polar solvent and at least one renewable solvent, such as 2-methyloxolane. In some other aspects, the one or more solvents having a boiling point range between about 36° C. to about 99° C. comprises at least one non-polar solvent and at least one polar solvent. In some other aspects, the one or more solvents having a boiling point range between about 36° C. to about 99° C. comprises at least one non-polar solvent, at least one polar solvent, and at least one renewable solvent, such as 2-methyloxolane. In yet another embodiment, the solvent extraction process is an extraction process using an azeotrope of a polar solvent and an alkane solvent.

In yet another embodiment, the solvent extraction process removes about 20% or more, about 25% or more, about 30% or more, about 35% or more, about 40% or more, about 45% or more, about 50% or more, about 55% or more, about 60% or more, about 65% or more, about 70% or more, about 75% or more, and in some aspects about 80% or more, of one or more aflatoxins. In some aspects, the solvent extraction process removes between about 20% and about 80%, in some aspects between about 25% and about 80%, in some aspects between about 30% and about 80%, in some aspects between about 35% and about 80%, in some aspects between about 45% and about 80%, in some aspects between about 50% and about 80%, in some aspects between about 55% and about 80%, and in some other aspects between about 60% and about 80%, of one or more aflatoxins present in the co-product prior to solvent extraction. In some other aspects, the solvent extraction process removes between about 20% and about 50%, in some aspects between about 20% and about 45%, in some aspects between about 20% and about 40%, of one or more aflatoxins present in the co-product prior to solvent extraction. In some aspects, the one or more aflatoxins are removed from the co-product from a solvent comprising hexane. In some aspects, the one or more aflatoxins are removed from the co-product from a solvent comprising 2-methyloxolane.

In yet another embodiment, the solvent extraction process removes about 20% or more, about 25% or more, about 30% or more, about 35% or more, about 40% or more, about 45% or more, about 50% or more, about 55% or more, about 60% or more, about 65% or more, about 70% or more, about 75% or more, and in some aspects about 80% or more, of one or more of zearalenone, HT2, T-2, or a combination thereof. In some aspects, the solvent extraction process removes between about 20% and about 80%, in some aspects between about 25% and about 80%, in some aspects between about 30% and about 80%, in some aspects between about 35% and about 80%, in some aspects between about 45% and about 80%, in some aspects between about 50% and about 80%, in some aspects between about 55% and about 80%, and in some other aspects between about 60% and about 80%, of one or more of zearalenone, HT2, T-2, or a combination thereof, present in the co-product prior to solvent extraction. In some other aspects, the solvent extraction process removes between about 20% and about 50%, in some aspects between about 20% and about 45%, in some aspects between about 20% and about 40%, of one or more of zearalenone, HT2, T-2, or a combination thereof, present in the co-product prior to solvent extraction. In some aspects, the one or more of zearalenone, HT2, T-2, or a combination thereof, are removed from the co-product from a solvent comprising hexane. In some aspects, the one or more of zearalenone, HT2, T-2, or a combination thereof, are removed from the co-product from a solvent comprising 2-methyloxolane.

In some aspects, the co-product prior to solvent extraction comprises one or more aflatoxins at an action level greater than 300 ppb, and after solvent extraction the co-product comprises the respective one or more aflatoxins at an acceptable level less than 300 ppb. In some aspects, the co-product prior to solvent extraction comprises one or more aflatoxins at an action level greater than 200 ppb, and after solvent extraction the co-product comprises the respective one or more aflatoxins at an acceptable level less than 200 ppb. In some aspects, the co-product prior to solvent extraction comprises one or more aflatoxins at an action level greater than 100 ppb, and after solvent extraction the co-product comprises the respective one or more aflatoxins at an acceptable level less than 100 ppb. In some aspects, the co-product prior to solvent extraction comprises one or more aflatoxins at an action level greater than 20 ppb, and after solvent extraction the co-product comprises the respective one or more aflatoxins at an acceptable level less than 20 ppb. In some preferred aspects, the co-product prior to solvent extraction comprises one or more aflatoxins at an action level greater than 20 ppb, and after solvent extraction the co-product comprises the respective one or more aflatoxins at a non-detectable level, wherein the detection level is at least 1.00 ppb. The one or more aflatoxins including AFB₁, AFB₂, AFG₁ and/or AFG₂.

In some aspects, the co-product prior to solvent extraction comprises zearalenone at an action level greater than 25 ppm, and after solvent extraction the co-product comprises zearalenone at an acceptable level less than 25 ppm. In some aspects, the co-product prior to solvent extraction comprises zearalenone at an action level greater than 10 ppm, and after solvent extraction the co-product comprises zearalenone at an acceptable level less than 10 ppm. In some aspects, the co-product prior to solvent extraction comprises zearalenone at an action level greater than 5 ppm, and after solvent extraction the co-product comprises zearalenone at an acceptable level less than 5 ppm. In some aspects, the co-product prior to solvent extraction comprises zearalenone at an action level greater than 2 ppm, and after solvent extraction the co-product comprises zearalenone at an acceptable level less than 2 ppm. In some aspects, the co-product prior to solvent extraction comprises zearalenone at an action level greater than 500 ppb, and after solvent extraction the co-product comprises zearalenone at an acceptable level less than 500 ppb. In some aspects, the co-product prior to solvent extraction comprises zearalenone at an action level greater than 300 ppb, and after solvent extraction the co-product comprises zearalenone at an acceptable level less than 300 ppb. In some preferred aspects, the co-product prior to solvent extraction comprises zearalenone at an action level greater than 300 ppb, and after solvent extraction the co-product comprises zearalenone at a non-detectable level, wherein the detection level is at least 12.50 ppb.

In some aspects, the co-product prior to solvent extraction comprises one or more fumonisins at an action level greater than 100 ppm, and after solvent extraction the co-product comprises the respective one or more fumonisins at an acceptable level less than 100 ppm. In some aspects, the co-product prior to solvent extraction comprises one or more fumonisins at an action level greater than 60 ppm, and after solvent extraction the co-product comprises the respective one or more fumonisins at an acceptable level less than 60 ppm. In some aspects, the co-product prior to solvent extraction comprises one or more fumonisins at an action level greater than 50 ppm, and after solvent extraction the co-product comprises the respective one or more fumonisins at an acceptable level less than 50 ppm. In some aspects, the co-product prior to solvent extraction comprises one or more fumonisins at an action level greater than 10 ppm, and after solvent extraction the co-product comprises the respective one or more fumonisins at an acceptable level less than 10 ppm. In some aspects, the co-product prior to solvent extraction comprises one or more fumonisins at an action level greater than 5 ppm, and after solvent extraction the co-product comprises the respective one or more fumonisins at an acceptable level less than 5 ppm. In some preferred aspects, the co-product prior to solvent extraction comprises one or more fumonisins at an action level greater than 5 ppm, and after solvent extraction the co-product comprises the respective one or more fumonisins at a non-detectable level, wherein the detection level is at least 0.10 ppm. The one or more fumonisins including FB₁, FB₂, and/or FB₃.

In some aspects, the co-product prior to solvent extraction comprises DON at an action level greater than 5 ppm, and after solvent extraction the co-product comprises DON at an acceptable level less than 5 ppm. In some aspects, the co-product prior to solvent extraction comprises DON at an action level greater than 2 ppm, and after solvent extraction the co-product comprises DON at an acceptable level less than 2 ppm. In some aspects, the co-product prior to solvent extraction comprises DON at an action level greater than 1 ppm, and after solvent extraction the co-product comprises DON at an acceptable level less than 1 ppm. In some aspects, the co-product prior to solvent extraction comprises DON at an action level greater than 0.5 ppm, and after solvent extraction the co-product comprises DON at an acceptable level less than 0.5 ppm.

In some aspects, the co-product prior to solvent extraction comprises T-2 at an action level greater than 750 ppb, and after solvent extraction the co-product comprises T-2 at an acceptable level less than 750 ppb. In some aspects, the co-product prior to solvent extraction comprises T-2 at an action level greater than 500 ppb, and after solvent extraction the co-product comprises T-2 at an acceptable level less than 500 ppb. In some aspects, the co-product prior to solvent extraction comprises T-2 at an action level greater than 300 ppb, and after solvent extraction the co-product comprises T-2 at an acceptable level less than 300 ppb. In some aspects, the co-product prior to solvent extraction comprises T-2 at an action level greater than 100 ppb, and after solvent extraction the co-product comprises T-2 at an acceptable level less than 100 ppb.

In some aspects, corn DDGS is subjected to a solvent extraction that reduces a level of one or more mycotoxins and results in a corn distillers meal having a residual oil content of no more than 3.0% by weight, in some aspects no mom than 2.5% by weight. In yet another embodiment, the solvent extraction process utilizes a solvent extraction process that reduces a level of one or more mycotoxins and results in a corn distillers meal having a residual oil content of approximately 2-3% by weight, in some other aspects approximately 0.25-6% by weight, in some other aspects approximately 1-5% by weight, and in still some other aspects approximately 0.25-3% by weight. In another embodiment, corn DDGS is subjected to a solvent extraction process that reduces a level of one or more mycotoxins and results in a corn distillers meal having a residual oil content of no more than 3.0% by weight, in some aspects no more than 2.5% by weight.

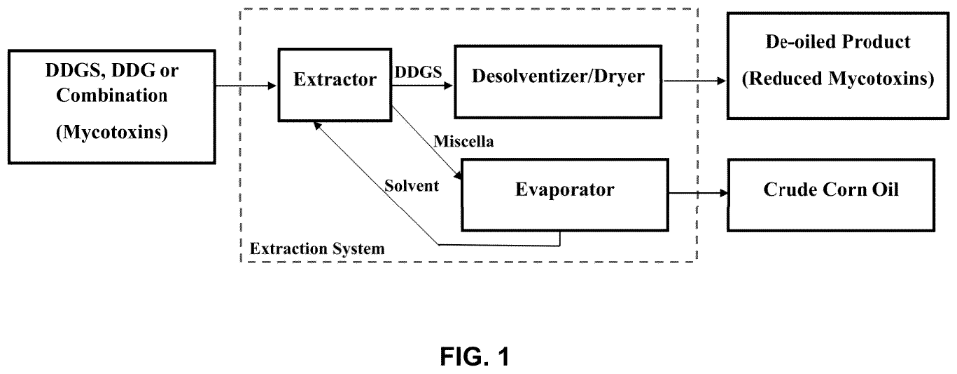

For exemplary illustration purposes, where the DDGS are produced at a dry-grind corn ethanol biorefinery, a flow-chart representation of suitable hexane extraction process is shown in FIG. 1. In a typical dry-grind process for ethanol production from corn, the DDGS and DDG are a by-product or co-product derived from the corn mash after the starch has been converted to ethanol and the ethanol has been removed by distillation. The stillage is typically subjected to centrifugation, evaporation and drying to remove residual liquid content, resulting in DDGS. Methods of extracting crude corn oil from corn DDGS are discussed in Sing et. al., “Extraction of Oil From Corn Distillers Dried Grains with Solubles”, Transactions of the ASAE 41 (6), 1775-1777 (1998), the teachings of which are incorporated by reference herein. In addition, solvent extraction technologies and equipment are available from, for example, Crown Iron Works Company of Minneapolis, Minn., U.S.A. Moreover, technology directed to removal of the oil from vegetable particles, removal of residual solvent from solvent extracted materials, and recovery of solvents used in solvent extraction processes are described in, for example, U.S. Pat. Nos. 6,996,917, 6,766,595, 6,732,454, and 6,509,051. These patents are assigned to Crown Iron Works Company, and the teachings of each of these patents are incorporated by reference herein. Still further, solvent extraction technologies relating to DDGS are disclosed in U.S. Pat. Nos. 8,227,015 and 9,113,645, the teachings of each of these patents being incorporated by reference herein.

Referring again to FIG. 1, which illustrates an embodiment of a solvent extraction process that may be applied to DDGS for removal of one or more mycotoxins, as a first step, DDGS meal is fed into an extractor. In some aspects, the DDGS meal may optionally be ground before being fed into an extractor to reduce the particle size of the DDGS meal. In some aspects, the DDGS meal is ground such that about 80%, in some aspects about 85%, in some aspects about 90%, in some aspects about 95%, in some aspects about 99%, and in some aspects about 100% of the DDGS meal has a particle size less than about 1 millimeter. In some aspects about 90% of the ground DDGS meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns. In other aspects, the DDGS meal is ground such that at least 95% of the DDGS meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns. In some other aspects, the DDGS meal is ground such that about 99% of the DDGS meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns.

In the extractor, the DDGS meal is washed with solvent, and in one embodiment, the DDGS meal is turned at least once in order to ensure that all DDGS particles are contacted as equally as practicable with solvent. After washing, the resulting mixture of oil and solvent, called miscella, is collected for separation of the extracted oil from the solvent. During the extraction process, as the solvent washes over the DDGS flakes, the solvent not only brings oil into solution, but may collect fine, solid DDGS particles. These “fines” are generally undesirable impurities in the miscella, and in one embodiment, the miscella is discharged from the separator through a device that separates or scrubs the fines from the miscella as the miscella is collected for separation of the oil from the solvent.

In order to separate the oil and the solvent contained in the miscella, the miscella may be subjected to a distillation step. In this step, the miscella can, for example, be processed through an evaporator, which heats the miscella to a temperature that is high enough to cause vaporization of the solvent and also potentially killing, detoxifying or inactivating one or more mycotoxins, but is not sufficiently high to adversely affect or vaporize the oil extracted by the solvent. The oil may be further stripped of solvent in an oil stripper to further reduce residual solvent levels and/or mycotoxin levels. As the solvent evaporates, it may be collected, for example, in a condenser, and recycled for future use. Separation of the solvent from the miscella results in a stock of renewable crude oil.

After extraction of the oil, the wet, de-oiled DDGS having levels of one or more mycotoxins reduced may be conveyed out of the extractor and subjected to a drying process that removes residual solvent. Removal of residual solvent is important to production of distillers meal suitable for use as an animal feed ingredient. In one embodiment, the wet meal can be conveyed in a vapor tight environment to preserve and collect solvent that transiently evaporates from the wet meal as it is conveyed into the desolventizer. As the meal enters the desolventizer, it may be heated to vaporize and remove the residual solvent. In order to heat the meal, the desolventizer may include a mechanism for distributing the meal over one or more trays, and the meal may be heated directly, such as through direct contact with heated air or steam, or indirectly, such as by heating the tray carrying the meal, or both. The desolventizer may further include multiple different trays for carrying the meal through different processing steps within the desolventizer. In order to facilitate transfer of the meal from one tray to another, the trays carrying the meal may include openings between trays that allow the meal to pass from one tray to the next.

Where the desolventizer utilizes multiple process steps to remove residual solvent from the wet, de-oiled DDGS to produce distillers meal having the levels of one or more mycotoxins reduced, the wet, de-oiled DDGS may be loaded and transferred through various trays to facilitate heating and solvent removal in multiple process steps. For example, in one embodiment, as the meal enters the desolventizer, it may be loaded on a first group of heated trays where the meal is evenly distributed and solvent vapor is flashed from the meal. From this first set of trays, the meal may be transferred onto a second group of trays, where it is again evenly distributed. The second set of trays may be heated indirectly by steam. The trays may be designed to allow venting of the solvent from one tray to the next and the meal contained in the second set of trays travels counter current to the solvent vapors. A third tray or set of trays may be provided to allow direct steam injection into the meal, which works to strip remaining solvent. Where the desolventizer includes multiple trays and utilizes multiple desolventizing processes, the quantity of trays and their positions may be designed to allow maximum contact between vapors and meal.

From the desolventizer, the meal may be conveyed to a dryer where the meal is dried of residual excess water and cooled to provide a finished distillers meal having acceptable levels of one or more mycotoxins. As it is conveyed into the dryer, the meal may be deposited into drying trays and it is warmed by heated air. As the meal is heated, residual water is vaporized. After drying, the meal may be cooled using ambient air. The desolventized, dried and cooled distillers meal may be stored, further processed, such as pelletizing to increase densification, or prepared for sale or distribution.

In some aspects, the desolventizing, toasting, drying and cooling processes can be accomplished in a single vessel referred to as a DTDC. In some aspects, the desolventizing and toasting processes are combined in one vessel, referred to as a DT, and the drying and cooling processes are combined in a separate vessel referred to as a DC. In some aspects, the desolventizing and toasting processes are conducted in a Crown® DT and the drying and cooling processes are conducted in a Crown® DC. In some aspects, in the DDGS desolventizing, toasting, drying and cooling process steps, 10 the solvent used to remove oil from the DDGS byproduct is removed from the de-oiled DDGS material and may be recovered for re-use, the de-oiled DDGS material is heated or toasted, the de-oiled DDGS material is dried to within acceptable moisture requirements, and the de-oiled DDGS material is cooled to near ambient temperature to remain flowable during storage and transport. The resultant desolventized, toasted, dried and cooled DDGS product is commonly referred to herein as corn distillers meal.

In some aspects, steam is injected into the DDGS byproduct during the oil extraction desolventization step, the live steam creating a sparging process. In some aspects, the live steam is applied during the desolventization step for at least 20 minutes, in some other aspects at least 25 minutes, more preferably at least 30 minutes, and in some other preferable aspects between about 20 minutes and about 50 minutes. In some aspects, the drum has a lower screen that can be used to facilitate the desolventization process.

In some aspects, the de-oiled, desolventized DDGS undergoes the heating and drying step by applying airflow at a temperature between about 200° F. and about 325° F., more preferably between about 250° F. and about 310° F., more preferably between about 265-F and about 310° F., and most preferably between about 275° F. and about 290° F., for a period of time between about 30 minutes to about 90 minutes, more preferably between about 40 minutes and about 80 minutes, most preferably between about 45 minutes and about 60 minutes, at a flow rate between about 15 CFM/T to about 75 CFM/T, more preferably between about 20 CFM/T to about 60 CFM/T, more preferably between about 25 CFM/T and about 50 CFM/T, and most preferably between about 25 CFM/T and about 30 CFM/T. In some aspects, the heating and drying steps are conducted in a DC having at least 3 dryer stacks, in some aspects in a DC having at least 4 dryer stacks, and in some other aspects in a DC having at least 5 dryer stacks.

In some aspects, after the heating and drying steps, the de-oiled, desensitized DDGS undergoes a cooling step. In some aspects, the de-oiled, desolventized, heated and dried DDGS is cooled in ambient air at a flow rate between about 25 CFM/T to about 60 CFM/T, more preferably between about 30 CFM/T to about 50 CFM/T, most preferably between about 35 CFM/T and about 45 CFM/T, for a period of time between about 5 minutes to about 30 minutes, more preferably between about 5 minutes and about 20 minutes, and most preferably about 10 minutes.

In some aspects, the desolventizing, toasting, drying and cooling processes can be accomplished in a single vessel referred to as a DTDC. In some aspects, the desolventizing and toasting processes are combined in one vessel, referred to as a DT, and the drying and cooling processes are combined in a separate vessel referred to as a DC. In the DDGS desolventizing, toasting, drying and cooling process path, the solvent used to remove oil from the DDGS byproduct is removed from the de-oiled DDGS material and may be recovered for re-use, the deoiled DDGS material is heated or toasted, the de-oiled DDGS material is dried to within acceptable moisture requirements, and the de-oiled DDGS material is cooled to near ambient temperature to remain flowable during storage and transport. The resultant desolventized, toasted, dried and cooled DDGS product is commonly referred to herein as corn distillers meal.

In some aspects, at least about 80%, in some aspects about 85%, in some aspects about 90%, in some aspects about 95%, in some aspects about 99%, and in some aspects about 100% of the distillers meal has a particle size less than about 1 millimeter. In some aspects about 90% of the distillers meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns. In other aspects, about 95% of the distillers meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns. In some other aspects, about 99% of the distillers meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns.

In some aspects, the distillers meal has an average particle size of about 105 microns to about 625 microns, in some aspects about 150 microns to about 600 microns, in some aspects about 175 microns to about 575 microns, in some aspects about 200 microns to about 525 microns, and in some aspects about 250 microns to about 500 microns.

In some aspects, the distillers meal may comprise a residual level of solvent utilized in the solvent extraction process in an amount of about 10 ppm to about 2000 ppm, in other aspects about 10 ppm to about 1000 ppm, in other aspects about 10 ppm to about 500 ppm, and still in some other aspects about 10 ppm to about 100 ppm. In some aspects, a residual level of hexane solvent is present in the distillers meal in an amount of about 10 ppm to about 2000 ppm, in other aspects about 10 ppm to about 1000 ppm, in other aspects about 10 ppm to about 500 ppm, in other aspects about 10 ppm to about 100 ppm, and in still other aspects about 100 ppm to about 500 ppm. In some aspects, a residual level of hexane solvent is present in the corn distillers meal in an amount of about 10 ppm to about 2000 ppm, in other aspects about 10 ppm to about 1000 ppm, in other aspects about 10 ppm to about 500 ppm, in other aspects about 10 ppm to about 100 ppm, and in still other aspects about 100 ppm to about 500 ppm. In some aspects, a residual level of 2-methyloxolane solvent is present in the distillers meal in an amount of about 10 ppm to about 2000 ppm, in other aspects about 10 ppm to about 1000 ppm, in other aspects about 10 ppm to about 500 ppm, in other aspects about 10 ppm to about 100 ppm, and in still other aspects about 100 ppm to about 500 ppm. In some aspects, a residual level of 2-methyloxolane solvent is present in the corn distillers meal in an amount of about 10 ppm to about 2000 ppm, in other aspects about 10 ppm to about 1000 ppm, in other aspects about 10 ppm to about 500 ppm, in other aspects about 10 ppm to about 100 ppm, and in still other aspects about 100 ppm to about 500 ppm.

In some aspects, the distillers meal may comprise a residual moisture content of about 3% to about 15%, in some aspects about 4% to about 13%, and still in other aspects about 7% to about 11%.

Water and/or Alcohol Extraction of Mycotoxins from DDGS and/or DDG

in some preferred aspects, after the DDGS and/or DDG has undergone the foregoing solvent extraction process, the resultant distillers meal may optionally undergo a water and/or alcohol washing process. In some aspects, the resultant distillers meal is washed with water, alcohol, or a combination thereof, to extract at least a portion of one or more mycotoxins.

In some other preferred aspects, prior to the solvent extraction process the DDGS and/or DDG undergo an optional water and/or alcohol washing process. In some aspects, the water and/or alcohol washing process prior to the solvent extraction process removes at least a portion of one or more mycotoxins.

In some preferred aspects, the feedstock, whether the resultant distillers meal from the solvent extraction process or DDGS and/or DDG, are fed into a filtration centrifuge having at least one washing zone, preferably at least two washing zones, more preferably at least three washing zones, and even more preferably at least four washing zones, whereby fiber and protein of the resultant distillers meal are separated by the centrifugal force and washing with water, alcohol, or a combination thereof. A commercially available filtration centrifuge, such as the maximized stillage co-products (MSC) system by Fluid-Quip, Inc.

In some aspects, the filtration centrifuge provides a counter-current washing of the feedstock (e.g., result distillers meal, DDGS and/or DDG) as it is fed through the centrifuge having a bowl design with screen inside the bowl with centrifugal forces over 1000 G-forces applied, such that the fiber of the resultant distillers meal is continually washed providing protein removal in the water and/or alcohol wash. In some aspects, the centrifuge filtration process provides a high protein content distillers meal, compared to the feedstock (e.g., resultant distillers meal or original DDGS and/or DDG). In some aspects, the high protein content distillers meal has a protein content between about 40% and about 60%, more preferably between about 45% and about 55%.

In some aspects, the water and/or alcohol washing provides a high protein content distillers meal having at least a portion of one or more mycotoxins extracted. In some aspects, at least a portion of one or more polar mycotoxins are removed by the washing process. In some aspects, the one or more polar mycotoxins removed by the washing process are chosen from ochratoxin A (OTA), fumonisin B₁, fumonisin B₂, fumonisin B₃, deoxynivalenol (DON), trichothecene T-2 toxin, trichothecene HT-2 toxin, nivalenol (NIV), zearalenone (ZEN), and ergot alkaloids (EAs).

In some preferred aspects, the washing process removes about 20% or more, about 25% or more, about 30% or more, about 35% or more, about 40% or more, about 45% or more, about 50% or more, about 55% or more, about 60% or more, about 65% or more, about 70% or more, about 75% or more, and in some aspects about 80% or more, of one or more mycotoxins present in the co-product prior to solvent extraction or remaining after solvent extraction. In some aspects, the washing process removes between about 20% and about 90%, in some aspects between about 25% and about 85%, in some aspects between about 30% and about 80%, in some aspects between about 35% and about 80%, in some aspects between about 45% and about 80%, in some aspects between about 50% and about 80%, in some aspects between about 55% and about 80%, and in some other aspects between about 60% and about 80%, of one or more mycotoxins present in the co-product prior to solvent extraction or remaining after solvent extraction.

In some preferred aspects, the washing process utilizes water in an amount of at least 50%, in some aspects at least 55%, in some aspects at least 60%, in some aspects at least 65%, in some aspects at least 70%, in some aspects at least 75%, in some aspects at least 80%, in some aspects at least 85%, in some aspects at least 90%, in some aspects at least 95%, in some aspects at least 99%, and in some aspects 100%. In some preferred aspects, the water comprises fresh water.

In some preferred aspects, the washing process utilizes aqueous ethanol in an amount between about 10% and about 80%, in some aspects between about 15% and about 60%, and in some preferred aspects between about 20% and about 50%.

Blending Mycotoxin Binders with Distillers Meal

After the solvent extraction of mycotoxins and the optional washing process, the resulting distillers meal can be blended with one or mycotoxin binders. Without wishing to be bound by theory, the one or more mycotoxin binders are believed to be adsorbent substances that partially or completely bind with one or more available mycotoxins resulting in reducing the bioavailable amount of mycotoxin in the distillers meal. As such, the mycotoxin binder inhibits the mycotoxin from being absorbed in the intestinal tract of the respective animal.

When one or more mycotoxin binders are used, the one or more mycotoxin binders can comprise one or more adsorbent substances, wherein the one or more absorbent substances can be an acid activated clay, a non-acid activated clay, bentonite clay, zeolite clay, diatomaceous earth, kaolin, a silica based product, aluminosilicates, including hydrated sodium calcium aluminosilicates, activated charcoal, glucomannan, chlorella, humic acid, calcium carbonate, and combinations thereof.

In some aspects, the one or more mycotoxin binders can comprise the resultant bleaching components from a bleaching treatment of a bio-oil derived from the DDGS, DDG and a combination thereof, such that the bleaching components from the bleaching step can be reused in another process, such as one or more mycotoxin binders for distillers meal. As such, the one or more mycotoxin binders may comprise a substance that has already been used in another process.

In some aspects, the one or more mycotoxin binders is capable of binding to one or more mycotoxins, such that the level of the one or more mycotoxins in the absence of the one or more mycotoxin binders is above an action level or acceptable bioavailable amount, and the presence of the one or more mycotoxin binders reduces the bioavailable amount within an acceptable level.

In some preferred aspects, the one or more mycotoxin binders are blended with the distillers meal in a loose meal form. In some other aspects, the one or more mycotoxin binders are blended with the distillers meal prior to a pelleting process.

While the foregoing disclosure relates to the presence of one or more mycotoxin binders, the present invention also contemplates the absence of one or more mycotoxin binders in the distillers meal in some preferred aspects. The absence of the one or more mycotoxin binders relates to the situation wherein the distillers meal already has one or more mycotoxin amounts in an acceptable amount as a result of the solvent extraction process and/or optional washing process, and also wherein one or more mycotoxin amounts are in an action level or above a desired bioavailable amount following the solvent extraction process and/or optional washing process.

### Distillers Meal

Besides having a reduced level of one or more mycotoxins compared to the starting co-product, the distillers meal produced by a solvent extraction method and an optional washing process as described herein may retain desired nutritional properties and remove other preferred characteristics or contaminants. The solvent extraction process applied to the DDGS and/or DDG may be chosen and tailored to reduce the level of one or more mycotoxins to a desired level while providing a distillers meal that exhibits nutritional properties suitable for animal feed applications. For example, in one embodiment, the DDGS are subjected to a solvent extraction process that provides distillers meal having the levels of one or more mycotoxin reduced while retaining substantially all the crude protein and fiber content of the DDGS prior to solvent extraction.

In an optional embodiment, the washing process may be utilized to remove one or more other mycotoxins and provide a high protein content distillers meal and a lower content of fiber, which may occur prior to or after the solvent extraction process. In some aspects, the high protein content distillers meal has a protein content between about 40% and about 70%, in some aspects between about 42.5% and about 60%, and more preferably between about 45% and about 55%.

In another embodiment, the distillers meal is corn distillers meal that retains substantially all of the crude protein and fiber content of the DDGS prior to solvent extraction.

In yet another embodiment, distillers meal is corn distillers meal that retains substantially all of the crude protein and fiber content of the DDGS prior to solvent extraction and is the product of a hexane extraction process conducted on corn DDGS produced by a dry-grind corn ethanol biorefinery.

For example, where the DDGS are corn DDGS and the solvent extraction process is a hexane extraction, the biorefining and solvent extraction processes may be controlled to provide corn distillers meal having the following nutrient content by weight on a dry matter basis: about 28% to about 35% crude protein; about 4% to about 6% total nitrogen; about 1% to about 5% crude fat; about 4% to about 6% ash; about 5% to about 7% crude fiber; about 11.5% to about 16.5% acid detergent fiber; about 25% to about 35% neutral detergent fiber; about 50% to about 55% nitrogen free extract; about 75% to about 80% total digestible nutrients (“TDN”); or a combination of two or more of any of the forgoing nutritional properties. In another embodiment, where the DDGS are corn DDGS and the solvent extraction process is a hexane extraction, the biorefining and solvent extraction processes may be controlled to provide corn distillers meal exhibiting about 0.80 to about 0.85 Mcal/lb net energy lactation (NE/Lactation), about 0.85 to about 0.89 Mcal/lb net energy maintenance (NE/maintenance), about 1200 to about 1250 kcal/lb of metabolizable energy, or about 0.55 to about 0.60 Mcal/lb of net energy gain (NE/gain), or any combination of two or more such characteristics.

It is contemplated that where the DDGS are corn DDGS and the solvent extraction process utilizes other solvents or mixtures of solvents containing alkanes, the biorefining and solvent extraction process may be controlled to provide corn distillers meal having the following nutrient content by weight on a dry matter basis: about 28% to about 35% crude protein; about 4% to about 6% total nitrogen; about 1% to about 5% crude fat; about 4% to about 6% ash; about 5% to about 7% crude fiber; about 11.5% to about 16.5% acid detergent fiber; about 25% to about 35% neutral detergent fiber, about 50% to about 55% nitrogen free extract; about 75% to about 80% total digestible nutrients (“TDN”); or a combination of two or more of any of the forgoing nutritional properties. In another embodiment, where the DDGS are corn DDGS and the solvent extraction process is a hexane extraction, the biorefining and solvent extraction processes may be controlled to provide corn distillers meal exhibiting about 0.80 to about 0.85 Mcal/lb net energy lactation (NE/Lactation), about 0.85 to about 0.89 Mcal/lb net energy maintenance (NE/maintenance), about 1200 to about 1250 kcal/lb of metabolizable energy, or about 0.55 to about 0.60 Mcal/lb of net energy gain (NE/gain), or any combination of two or more such characteristics.

The distillers meal may be further processed, as desired, to provide a distillers meal product having desired characteristics, such as, for example, a desired flowability or density. Moreover, the distillers meal may be further processed to provide a product that is more easily packaged and distributed as an ingredient in a feed. Even further, the distillers meal may be processed to incorporate additional constituents to increase the feeding palatability or nutritional quality. For example, in one embodiment, the distillers meal may be further processed to incorporate a salt or a syrup from another manufacturing process that provides additional protein content. In another embodiment, the distillers meal may be pelleted to provide a feed material that is more readily packaged for sale and transport and is more easily incorporated into or used as an animal feed. For instance, Example 2 provides a description of an embodiment of corn distillers meal according to the description provided herein, as well as suitable process conditions for pelletizing the corn distillers meal described therein. Tables presented in Example 2 set out the process conditions under which the corn distillers meal was pelletized, describe a selection of physical properties exhibited by the non-pelleted and the pelleted corn distillers meal, and highlight a selection of nutritional properties exhibited by the non-pelleted and the pelleted corn distillers meal.

In some aspects, the solvent extracted crude oil from DDGS enhances the nutritional profile of the distillers meal by increasing the percentage of protein and amino acids contained in the distillers meal. For example, conventional corn DDGS having a corn oil content of about 10% typically has a lysine content of about 0.75% by weight on a dry matter basis. In comparison, corn distillers meal of the present invention that has a residual corn oil content of about 2% has a lysine content of about 0.81% by weight on a dry matter basis. This increase in lysine content in the corn distillers meal, when compared to the ratio of residual fat, results in a lysine to residual fat ratio percentage (% lysine/% residual fat)*100 of about 7.5 for conventional corn DDGS, as compared to a lysine to residual fat ratio of about 40.5 for corn distillers meal of the present invention.

In some aspects, the lysine content of corn distillers meal ranges from about 0.7% to about 1.0% for corn distillers meal having a residual fat content between about 0.5% to about 3.0%. As a result, the lysine to residual fat ratio for corn distillers meal is between about 23.3 to about 140 at a lysine content of about 0.7%, between about 26.7 and about 160 at a lysine content of about 0.8%, between about 30 and about 180 at a lysine content of about 0.9%, and between about 33.3 and about 200 at a lysine content of about 1.0%. Thus, corn distillers meal of the present invention may have a lysine to residual fat ratio between about 20 to about 200, in some aspects about 25 to about 180, in some aspects about 30 to about 160, and in some other aspects about 40 to about 140, with other ranges and subranges of the foregoing ranges contemplated herein. In comparison to an ethanol plant employing the CSO recovery method, and assuming a high native lysine content of about 0.9% and a residual fat content of about 4%, the lysine to residual fat ratio would at the very most be about 20.

When one or more of the specific fatty acids in the residual fat composition of the corn distillers meal are considered as opposed to the total residual fat, such as linoleic acid (C18:2) or oleic acid (C18:1), the ratios are further enhanced. For example, in the situation of linoleic acid, which is about 45% to about 60% of the total fatty acid content, and for the sake of this example assumed to be 50%, the lysine to linoleic acid ratio in corn distillers meal is in the range of about 46.6 to about 280 at a lysine content of about 0.7%, between about 53.4 and about 320 at a lysine content of about 0.8%, between about 60 and about 360 at a lysine content of about 0.9%, and between about 66.6 and about 400 at a lysine content of about 1.0%. Thus, corn distillers meal of the present invention may have a lysine to residual linoleic acid ratio between about 45 to about 400, in some aspects about 50 to about 360, in some aspects about 60 to about 320, and in some other aspects about 80 to about 280, with other ranges and subranges of the foregoing ranges contemplated herein. In comparison to an ethanol plant employing the CSO recovery method, and assuming a high native lysine content of about 0.9% and a residual fat content of about 4%, the lysine to residual linoleic acid ratio would at the very most be about 40.

When oleic acid is used as the specific fatty acid instead of the total residual fat or linoleic acid, the ratios are even further enhanced. For example, in the situation of oleic acid, which is about 20% to about 40% of the total fatty acid content, and for the sake of this example assumed to be 25%, the lysine to oleic acid ratio in corn distillers meal is in the range of about 85 to about 560 at a lysine content of about 0.7%, between about 105 and about 640 at a lysine content of about 0.8%, between about 120 and about 720 at a lysine content of about 0.9%, and between about 125 and about 800 at a lysine content of about 1.0%. Thus, corn distillers meal of the present invention may have a lysine to residual oleic acid ratio between about 85 to about 800, in some aspects about 105 to about 720, in some aspects about 120 to about 640, and in some other aspects about 160 to about 560, with other ranges and subranges of the foregoing ranges contemplated herein. In comparison to an ethanol plant employing the CSO recovery method, and assuming a high native lysine content of about 0.9% and a residual fat content of about 4%, the lysine to residual linoleic acid ratio would at the very most be about 40.

Conventionally, the protein content percentage in meals, such as flours, grains and oilseeds, is defined as the total nitrogen times 6.25, for example 1% total nitrogen equals 6.25% protein. In conventional DDGS, including corn DDGS, the ratio of total nitrogen to total free fatty acids is less than 25. In distillers meal of the present invention, including corn distillers meal, the ratio of total nitrogen to total free fatty acids is greater than 25 up to about 200, in some aspects about 35 to about 200, and still in other aspects about 50 to about 200. In some aspects of the present invention, the total free fatty acid content in solvent extracted oil is about 2% to about 10%, in some aspects about 3% to about 9%, and in some aspects about 5% to about 8%, and in some further aspects about 7% to about 8%. In comparison, the fatty free acid content resulting from the CSO recovery method would be inherently higher due to the hydrolytic splitting of the oil in the presence of water required for the CSO recovery method. As such, a free fatty acid content of about 10% or even higher for the CSO recovery method is not unusual.

### Distillers Meal as an Animal Feed or Animal Feed Supplement

DDGS are often used as a feed supplement for livestock and poultry fed high grain content finishing diets. Before solvent extraction, DDGS may have approximately 30% by weight crude protein (“CP”) and 20% crude fiber (“CF”). Distillers meal as described herein provides a high-quality, low-cost protein feed that can be fed at higher inclusion rates for animals, such as domestic pets, livestock or poultry. In addition, as described herein, livestock feed comprising distillers meal exhibit desirable carcass traits, and the nutritional properties of distillers meal may provide a superior feed or feed supplement.

In one embodiment, the distillers meal disclosed herein may be used to supplement animal diets at a desired percentage of the total diet, on a dry matter basis. In one embodiment, the distillers meal may be used as a CP supplements in livestock and poultry feed diets. In addition, the distillers meal described herein may also be used as an animal feed or feed supplement that provides desired amounts of carbohydrates, fiber or non-protein nitrogen (NPN) containing compounds. The distillers meal can be used at a percentage of the total feed that maximizes the nutritional components of the feed. The relative amount of distillers meal incorporated into an animal diet may depend on, for example, the species, sex, or agricultural use of the animal being fed. Additionally, the relative amount of distillers meal incorporated into a particular diet may depend on the nutritional goals of the diet.

In one embodiment, distillers meal may be used to provide approximately 50% to approximately 75% by weight, on a dry matter basis, of a total diet for use in an animal feed. In one such embodiment, the distillers meal is corn distillers meal as described herein and is used to provide approximately 50% to 55%, 50% to 60%, 50% to 65%, or 50% to 70% by weight, on a dry matter basis, of the total diet. In some aspects, the distillers meal is substituted in an animal feed diet for soybean meal, corn, DDGS and/or other protein supplements in rations for such animal. In another such embodiment, the distillers meal is corn distillers meal as described herein and is used to provide approximately 50% to 55%, 55% to 60%, 55% to 70%, 60% to 65%, 60% to 70%, or 70% to 75% by weight, on a dry matter basis, of the total diet. In some aspects, the corn distillers meal is substituted in an animal feed diet for soybean meal, corn, DDGS and/or other protein supplements in rations for such animal.

In another embodiment, distillers meal as described herein may be used to provide approximately 0 to 5%, approximately 5% to 10%, approximately 5% to 15%, approximately 5% to 25%, approximately 5% to 30%, approximately 10% to 15%, approximately 15% to 20%, approximately 20% to 25%, approximately 25% to 30%, approximately 30% to 35%, approximately 35% to 40%, approximately 40% to 45%, or approximately 45% to 50% by weight, on a dry matter basis, of a total animal diet. In one such embodiment, distillers meal as described herein is used as a CP supplement in a cattle diet, and the distillers meal provides approximately 5% to 20% by weight, on a dry matter basis, of the total diet. In yet another such embodiment, distillers meal as described herein is used as a CP supplement in a cattle diet, and the distillers meal provides approximately 5% to 15% by weight, on a dry matter basis, of the total diet. In still yet another such embodiment, distillers meal as described herein is used as a CP supplement in a cattle diet, and the distillers meal provides approximately 10% to 15% by weight, on a dry matter basis, of the total diet. In yet another such embodiment, distillers meal as described herein is used as a CP supplement in a cattle diet, and the distillers meal provides approximately 10% to 12% by weight, on a dry matter basis of the total diet. In another such embodiment, distillers meal as described herein is used as a CP supplement in a cattle diet, and the distillers meal provides approximately 7% to 12% by weight, on a dry matter basis, of the total diet. In each of the preceding embodiments, where the distillers meal is fed to cattle, the distillers meal may be corn distillers meal as described herein and the cattle may be finishing cattle.

In another embodiment, distillers meal as described herein may be used in feeding dairy cattle. Where corn distillers meal is used as a dairy cattle feed, it may be provided at, for examples, up to approximately 30%, approximately 5% to 30%, approximately 5% to 25%, approximately 5% to 20%, approximately 5% to 15%, approximately 10% to 15%, approximately 15% to 20%, approximately 15% to 25%, approximately 15% to 30%, approximately 10% to 20%, approximately 10% to 25%, approximately 20% to 25%, or approximately 25% to 30% by weight, on a dry matter basis, of the total diet. In each of the exemplary embodiments, where the distillers meal is fed to dairy cattle, the distillers meal may be corn distillers meal as described herein.

In another embodiment, distillers meal as described herein is used as a feed supplement for cattle to achieve a desired F/G ratio. As it is used herein, the term “F/G ratio” refers to the ratio of pounds of feed per pound of daily gain. In one embodiment, distillers meal as described herein is used as a cattle feed supplement to achieve an F/G ratio of 4.5 or less after 4 weeks of feeding. In another embodiment, distillers meal as described herein is used as a cattle feed supplement to achieve an F/G ratio of 5.0 or less after 8 weeks of feeding. In yet another embodiment, distillers meal as described herein is used as a cattle feed supplement to achieve an F/G ratio of 6.5 or less after 12 weeks of feeding. In yet another embodiment, distillers meal as described herein is used as a cattle feed supplement to achieve an F/G ratio of 7.0 or less after 16 weeks of feeding. In yet another embodiment, distillers meal as described herein is used as a cattle feed supplement to achieve an F/G ratio of 6.5 or less through 18 weeks of feeding. In each of the embodiments described herein pertaining to use of distillers meal as a feed supplement in cattle to achieve a desired F/G ratio, the distillers meal may be corn distillers meal, the cattle may be, for example, finishing cattle, and the corn distillers meal may provide, for example, approximately 5% to 15%, 5% to 10%, 7%-12%, or 10% to 12% by weight, on a dry matter basis, of the total diet. Alternatively, in each of the embodiments described herein pertaining to use of distillers meal as a feed supplement in cattle to achieve a desired F/G ratio, the distillers meal may be corn distillers meal, the cattle may be, for example, finishing cattle, and the corn distillers meal may provide, for example, approximately 5%, 6%, 7%, 8%, 9%, 10%, 11%, 12%, 13%, 14%, or 15% by weight, on a dry matter basis, of the total diet.

In yet another embodiment, distillers meal as described herein may be used as a feed supplement for cattle to achieve a desired average daily gain (ADG). In one embodiment, distillers meal as described herein is used as a cattle feed supplement to achieve an ADG of 4.0 lbs or greater after 4 weeks of feeding. In another embodiment, distillers meal as described herein is used as a cattle feed supplement to achieve an ADG of 4.5 lbs or greater after 8 weeks of feeding. In yet another embodiment, distillers meal as described herein is used as a cattle feed supplement to achieve an ADO of 3.5 lbs or greater after 12 weeks of feeding. In yet another embodiment, distillers meal as described herein is used as a cattle feed supplement to achieve and maintain an ADG of 3.5 lbs or greater through 16 weeks of feeding. In yet another embodiment, distillers meal as described herein is used as a cattle feed supplement to achieve and maintain an ADG of 3.5 lbs or greater through 18 weeks of feeding. In yet another embodiment, distillers meal as described herein is used as a cattle feed supplement to achieve an ADO of 4.0 lbs or greater after 18 weeks of feeding. In each of the embodiments described herein pertaining to use of distillers meal as a feed supplement in cattle to achieve a desired ADG, the distillers meal may be corn distillers meal, the cattle may be, for example, finishing cattle, and the corn distillers meal may provide, for example, approximately 5% to 15%, 5% to 10%, 7%-12%, or 10% to 12% by weight, on a dry matter basis, of the total diet. Alternatively, in each of the embodiments described herein pertaining to use of distillers meal as a feed supplement in cattle to achieve a desired ADG, the distillers meal may be corn distillers meal, the cattle may be, for example, finishing cattle, and the corn distillers meal may provide, for example, approximately 5%, 6%, 7%, 8%, 9%, 10%, 11%, 12%, 13%, 14%, or 15% by weight, on a dry matter basis, of the total diet.

The distillers meal may be provided in meal form or in pellet form or other forms useful for feeding livestock or poultry, as would be recognized in the art. The distillers meal may also be premixed with other desired ingredients of a livestock or poultry diet and provided for use in a ready-to-feed form. In addition to distillers meal as described herein, livestock and poultry diets as described herein may further include, for example, desired percentages of other components such as feed corn, corn meal, soybean meal, urea, hay, pre-prepared cattle feeds, protein supplements, mineral supplements, liquid supplements and other feed components as known and used by those of skill in the art. Other acceptable materials used in livestock and poultry feed may include, for example, soybeans, soy hulls, soybean protein derivatives, wheat, wheat middling, wheat straw, alfalfa, sugar beet tailings, sugar beet pulp, sugar beets, corn stalks, corn cobs, popcorn husks, sweet bran, silage, meat and bone meal, molasses, oats, oat straw, barley, barley straw, sunflower seeds and hulls, milo, and wild grass, cottonseed by-products, such as delinted whole cottonseed, fuzzy cottonseed, and by-products of other oil seeds.

In some aspects, the distillers meal as described herein is used as a feed supplement or formula feed for beef cattle, including the beef cattle classes of calves, cattle on pasture and/or feedlot cattle. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a maximum percentage of equivalent crude protein from non-protein nitrogen of about 6%, in some aspects about 5%, and in some aspects about 4%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; and a minimum percentage of potassium in an amount of about 0.8%, in some aspects about 0.85%, in some aspects about 0.9%, in some aspects about 0.95%, and in some other aspects about 1.0%.

In some aspects, the distillers meal as described herein is used as a feed supplement or feed formula for dairy cattle, particularly veal milk replacer and/or herd milk replacer. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; and a minimum percentage of phosphorous in an amount of about 0.8%, in some aspects about 0.85%, in some aspects about 0.9%, in some aspects about 0.95%, and in some other aspects about 1.0%.

In some aspects, the distillers meal as described herein is used as a feed supplement or feed formula for dairy cattle, particularly starter, growing heifers, bulls and dairy beef, lactating dairy cattle and/or non-lactating dairy cattle. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a maximum percentage of equivalent crude protein from non-protein nitrogen of about 6%, in some aspects about 5%, and in some aspects about 4%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a maximum percentage of acid detergent fiber in an amount of about 16.5%, in some aspects about 15.5%, in some aspects about 14.5%, in some aspects about 13.5%, in some aspects about 12.5%, and still in some other aspects about 11.5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; and a minimum selenium in an amount below detection limits of about 2.25 ppm.

In some aspects, the distillers meal as described herein is used as a feed supplement or feed formula for equine, including foal, mare, breeding and/or maintenance equine. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.091%; a minimum percentage of phosphorous in an amount of about 0.7%, in some aspects about 0.75%, and in some other aspects about 0.8%; a minimum amount of copper of about 3 ppm, in some aspects about 4 ppm, in some aspects about 5 ppm, in some aspects about 6 ppm; a minimum selenium in an amount below detection limits of about 2.25 ppm; and a minimum zinc of about 50 ppm, in some aspects about 55 ppm, in some aspects about 60 ppm, in some aspects about 65 ppm, in some aspects about 70 ppm, and in some other aspects about 75 ppm.

In some aspects, the distillers meal as described herein is used as a feed supplement or feed formula for swine, including pre-starter, starter, grower, finisher, gilts, sows and adult boars, lactating gilts and/or lactating sows. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of lysine in an amount of about 0.7%, in some aspects about 0.75%, in some aspects about 0.8%, in some aspects about 0.85%, in some aspects about 0.9%, in some aspects about 0.95%, and in some other aspects about 1.0%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; a minimum selenium in an amount below detection limits of about 2.25 ppm; and a minimum zinc of about 50 ppm, in some aspects about 55 ppm, in some aspects about 60 ppm, in some aspects about 65 ppm, in some aspects about 70 ppm, and in some other aspects about 75 ppm.

In some aspects, the distillers meal as described herein is used as a feed supplement or feed formula for poultry, including layer chickens (starting/growing, finisher, laying and/or breeder), broiler chickens (starting/growing, finisher and/or breeder), broiler breeder chickens (starting/growing, finishing and/or laying) and/or turkeys (starting/growing, finisher, laying and/or breeder). The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of lysine in an amount of about 0.7%, in some aspects about 0.75%, in some aspects about 0.8%, in some aspects about 0.85%, in some aspects about 0.9%, in some aspects about 0.95%, and in some other aspects about 1.0%; a minimum percentage of methionine of about 0.50%, in some aspects about 0.55%, in some aspects about 0.60%, in some other aspects about 0.65%, and in some other aspects about 0.7%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; and a minimum percentage of phosphorous in an amount of about 0.7%, in some aspects about 0.75%, and in some other aspects about 0.8%.

In some aspects, the distillers meal as described herein is used as a feed supplement or feed formula for a goat, including starter, grower, finisher, breeder and/or lactating goats. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a maximum percentage of equivalent crude protein from non-protein nitrogen of about 6%, in some aspects about 5%, and in some aspects about 4%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; a minimum amount of copper of about 3 ppm, in some aspects about 4 ppm, in some aspects about 5 ppm, in some aspects about 6 ppm, and a maximum amount of copper of about 10 ppm, in some aspects about 9 ppm, in some aspects about 8 ppm, in some aspects about 7 ppm, and in some other aspects about 6 ppm; and a minimum selenium in an amount below detection limits of about 2.25 ppm.

In some aspects, the distillers meal as described herein is used as a feed supplement or feed formula for sheep, including starter, grower, finisher, breeder and/or lactating sheep. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a maximum percentage of equivalent crude protein from non-protein nitrogen of about 6%, in some aspects about 5%, and in some aspects about 4%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; a minimum amount of copper of about 3 ppm, in some aspects about 4 ppm, in some aspects about 5 ppm, in some aspects about 6 ppm, and a maximum amount of copper of about 10 ppm, in some aspects about 9 ppm, in some aspects about 8 ppm, in some aspects about 7 ppm, and in some other aspects about 6 ppm; and a minimum selenium in an amount below detection limits of about 2.25 ppm

In some aspects, the distillers meal as described herein is used as a feed supplement or feed formula for ducks and/or geese, including starter, grower, finisher, breeder developer and/or breeder. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; and a minimum percentage of phosphorous in an amount of about 0.7%, in some aspects about 0.75%, and in some other aspects about 0.8%.

In some aspects, the distillers meal as described herein is used as a feed supplement or feed formula for fish, including trout, catfish and other species other than trout or catfish. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; and a minimum percentage of phosphorous in an amount of about 0.7%, in some aspects about 0.75%, and in some other aspects about 0.8%.

In some aspects, the distillers meal as described herein is used as a feed supplement or feed formula for rabbit, including grower and/or breeder. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a minimum percentage of crude fiber in an amount of about 7%, in some aspects about 6%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; and a minimum percentage of phosphorous in an amount of about 0.7%, in some aspects about 0.75%, and in some other aspects about 0.8%.

In some aspects, the distillers meal as described herein is used as a feed supplement or feed formula for cats and/or dogs.

In some aspects, the distillers meal as described herein is essentially free of one or more mycotoxins that was present in the co-product prior to the solvent extraction process or the optional water washing process.

In some other aspects, the solvent extraction of a co-product provides a feedstock that can be used in further processing to make a protein enriched or purified/isolated protein product. In some preferred aspects, the purified/isolate protein product is a purified/isolated corn protein product. In some aspects, the purified/isolated corn protein product produced from the feedstock can be a feed supplement, feed formula or feed product for one or more of the foregoing animals. In some aspects, the purified/isolate protein product is provided by a combination of the solvent extraction and water washing processes. In some aspects, the high protein content distillers meal has a protein content between about 40% and about 70%, in some aspects between about 42.5% and about 60%, and more preferably between about 45% and about 55%.

In some preferred aspects, the solvent extraction process and the optional washing process provide a feed supplement or feed product from a co-product, wherein the co-product prior to the solvent extraction process and the optional water washing process would be an unacceptable feed supplement or feed product under animal food specifications, but after undergoing the solvent extraction process and the optional water washing process now meet the animal food specifications.

### EXAMPLE

A distillers meal resulting from the solvent extraction of corn DDGS from an ethanol processing facility comprised the mycotoxin screen results shown in Table 1, wherein the method of detection comprised liquid chromatography and mass spectrometry analysis (LC/MS).

TABLE 1
Mycotoxin screen results of
distillers meal post-solvent extraction process.

| Toxin Screen | Result | Tested Level | Detection Level |
|---|---|---|---|
| Aflatoxin B1 | Non-Detect | | 1.00 ppb |
| Aflatoxin B2 | Non-Detect | | 1.00 ppb |
| Aflatoxin G1 | Non-Detect | | 1.00 ppb |
| Aflatoxin G2 | Non-Detect | | 1.00 ppb |
| DON | Positive | 0.3 ppm | 0.10 ppm |
| Zearalenone | Non-Detect | | 12.50 ppb |
| Ochratoxin | Non-Detect | | 1.00 ppb |
| T2 | Positive | 6.1 ppb | 5.00 ppb |
| HT2 | Positive | 25.6 ppb | 5.00 ppb |
| Fumonisin B1 | Positive | 0.2 ppm | 0.10 ppm |
| Fumonisin B2 | Non-Detect | | 0.10 ppm |
| Fumonisin B3 | Non-Detect | | 0.10 ppm |

The foregoing mycotoxin screen data in Table 1 provides acceptable levels of all aflatoxins, DON, zearalenone, ochratoxin, T2, HT2 and fumonisins for all types of livestock. While there were positive detections for DON, T2, HT2 and Fumonisin B1, the tested levels were well below the acceptable levels for all types of livestock. It is anticipated that the positive detection levels for each of DON, T2, HT2 and Fumonisin B1 would be further lowered, if not to the non-detect level, had the distillers meal been subjected to a washing process. The amount of bioavailable mycotoxin amounts are also anticipated to be able to be further lowered should the distillers meal be blended with one or more mycotoxin binders.

The method, compositions and systems disclosed and claimed herein can comprise, consist of, or consist essentially of the essential elements and limitations of the method, compositions and/or systems described herein. Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method of producing a distillers meal having a reduced level of one or mycotoxins, the method comprising:
providing a co-product resulting from a fermentation process of a dry-grind biofuel production facility, wherein the dry-grind biofuel production facility uses a bio-based feedstock to produce a biofuel and the co-product, the co-product comprising distillers dried grains with solubles, distiller's dried grains, or a combination thereof, and wherein one or more mycotoxins are present in the co-product; and
conducting solvent extraction of the co-product in the presence of one or more solvents to extract an amount of one or more mycotoxins from the co-product and provide a distillers meal;
wherein the distillers meal has a level of the one or more mycotoxins that is reduced compared to the co-product prior to the solvent extraction process.

2. (canceled)

3. Distillers meal produced from a dry-grind biofuel production facility configured to process a bio-based feedstock to produce a biofuel and a co-product, wherein the co-product is subjected to a solvent extraction process providing the distillers meal, the distillers meal comprising:
a crude protein content ranging from about 28% to about 35% by weight on a dry matter basis, a crude fat content ranging from about 0.25% to about 6% by weight on a dry matter basis;
wherein the distillers meal has a level of the one or more mycotoxins that has been reduced by solvent extraction compared to the co-product.

4. An animal feed ingredient comprising distillers meal produced from a dry-grind biofuel production facility configured to process a bio-based feedstock to produce a biofuel and a co-product, the co-product comprising distillers dried grains with solubles, distiller's dried grains, or a combination thereof, wherein the co-product is subjected to a solvent extraction process providing the distillers meal, wherein the distillers meal having a crude protein content ranging from about 28% to about 35% by weight on a dry matter basis, a crude fat content ranging from about 0.25% to about 6% by weight on a dry matter basis, wherein the distillers meal has a level of the one or more mycotoxins that has been reduced by solvent extraction compared to the co-product.

5. The method of claim 1, wherein the bio-based feedstock comprises one or more fermentable sugars or starches.

6. The method of claim 1, wherein the one or more mycotoxins is chosen from aflatoxin B₁ (AFB₁), aflatoxin B₂ (AFB₂), aflatoxin G₁ (AFG₁), aflatoxin G₂ (AFG₂), ochratoxin A (OTA), fumonisin B₁ (FB₁), fumonisin B₂ (FB₂), fumonisin B₃ (FB₃), deoxynivalenol (DON) trichothecene T-2 toxin (T-2) trichthecene HT-2 toxin (HT-2), nivalenol (NIV), zearalenone (ZEN), patulin (PAT), one or more ergot alkaloids (EAs), and combinations thereof.

7. The method of claim 1, wherein the distillers meal comprises a residual level of the non-polar solvent in an amount of about 10 ppm to about 1000 ppm.

8. The method of claim 1, wherein the distillers meal is corn distillers meal produced by solvent extraction of corn distillers dried grains with solubles, corn distiller's dried grains, or a combination thereof.

9. The method of claim 1, wherein the distillers meal is produced by solvent extraction of corn distillers dried grains with soluble, corn distiller's dried grains, or a combination thereof, the solvent comprising one or more alkanes C₅-C₇-alkanes chosen from n-pentane, n-hexane, n-heptane, isopentane, neopentane, isohexane, 2-methylepentane, 2,3-dimethylbutane, neohexane, isoheptane, 2-methylhexane, 2,2-dimethylpentane, 2,3-dimethylpentane, 2,4-dimethyl pentane, 3-ethylpentane, and 2,2,3-trimethylbutane, petroleum ether, or mixtures thereof.

10. The method of claim 1, wherein the distillers meal is produced by solvent extraction of the co-product with at least one renewable solvent comprising 2-methyloxolane.

11-14. (canceled)

15. The method of claim 1, wherein the solvent extraction process removes about 20% or more of one or more mycotoxins present in the co-product prior to solvent extraction to provide the distillers meal.

16. The method of claim 1, wherein the solvent extraction process removes between about 20% and about 80% of one or more mycotoxins present in the co-product prior to solvent extraction to provide the distillers meal.

17. (canceled)

18. The method of claim 1, wherein the co-product comprises one or more aflatoxins chosen from AFB₁, AFB₂, AFG₁, AFG₂, and combinations therefore, at an action level prior to the solvent extraction process and at an acceptable level after the solvent extraction level, wherein the action level is greater than 300 ppb and the acceptable level less than 300 ppb.

19. The method of claim 1, wherein the co-product comprises zearalenone at an action level prior to the solvent extraction process and at an acceptable level after the solvent extraction level, wherein the action level is greater than 25 ppm and the acceptable level less than 25 ppm.

20. The method of claim 1, wherein the co-product comprises one or more fumonisins including FB₁, FB₂, FB₃, and combinations thereof, at an action level prior to the solvent extraction process and at an acceptable level after the solvent extraction level, wherein the action level is greater than 100 ppm and the acceptable level less than 100 ppm.

21. The method of claim 1, wherein the co-product comprises DON at an action level prior to the solvent extraction process and at an acceptable level after the solvent extraction level, wherein the action level is greater than 5 ppm and the acceptable level less than 5 ppm.

22. The method of claim 1, wherein the co-product comprises T-2 at an action level prior to the solvent extraction process and at an acceptable level after the solvent extraction level, wherein the action level is greater than 750 ppb and the acceptable level less than 750 ppb.

23. The method of claim 1, wherein the distillers meal is provided in an animal feed or an animal feed supplement for an animal chosen from beef cattle, dairy cattle, equine, sheep, swine, fish, chickens, geese, turkey, rabbits, goats, cats and dogs.

24. (canceled)

25. The method of claim 1, wherein the distillers meal is substantially free of a non-native emulsifier or a non-native flocculent.

26. The method of claim 1, wherein the distillers meal has at least a 50% reduced level of an emulsifier or a flocculent than distillers dried grain solubles that has been subjected to a corn stillage oil recovery process.

27-28. (canceled)

29. The method of claim 1, wherein the distillers meal is essentially free of one or more mycotoxins that was present in the co-product prior to the solvent extraction process.

30-35. (canceled)
